(19) United States
(12) Patent Application Publication
(10) Pub. No.: US 2007/0013292 A1
(43) Pub. Date: Jan. 18, 2007

(54) Organic electroluminescent device and method for manufacturing same

(76) Inventors: Hirotada Inoue, Osaka (JP); Hisao Haku, Osaka (JP); Gaku Harada, Osaka (JP)

Correspondence Address: MCDERMOTT WILL & EMERY LLP, 600 13TH STREET, N.W., WASHINGTON, DC, 20005-3096, US

(21) Appl. No.: 10/544,377

(22) PCT Filed: Feb. 2, 2004
(86) PCT No.: PCT/JP04/00985

§ 371 Date: Jun. 12, 2006

(30) Foreign Application Priority Data
Feb. 4, 2003 (JP) 2003-027653

(51) Int. Cl. H01J 1/62; H01J 63/04

(52) U.S. Cl. 313/504

(57) ABSTRACT

A plurality of organic EL devices are formed first on a substrate. Next, a film of a sealing agent is formed over the outer periphery of a lower surface (color filter side) of a sealing plate. Then, a sealing agent is dropped onto a central portion of the sealing plate. After that, the sealing plate and the substrate are laminated at a predetermined pressure in a vacuum chamber in a vacuum, and then the vacuum chamber is released from its vacuum state. The substrate and the sealing plate are removed from the vacuum chamber, and the sealing agents between the substrate and the sealing plate are cured by the curing methods suitable for the respective materials.

### TECHNICAL FIELD

The present invention relates to organic electroluminescent apparatuses including organic electroluminescent devices and methods of fabricating the organic electroluminescent apparatuses.

### BACKGROUND ART

The recent diversification of information equipment has led to a growing need for flat panel display devices that require less power consumption than generally used CRTs (Cathode Ray Tubes). As one of such flat panel display devices, organic electroluminescent (hereinafter abbreviated to organic EL) devices having such features as high efficiency, small thickness, lightweight, and low viewing angle dependency are attracting attention. Displays using such organic EL devices are actively being developed.

Organic EL devices are self-emitting devices. In an organic EL device, electrons are injected into the luminescent region from an electron injection electrode, and holes are injected into the luminescent region from a hole injection electrode. The injected electrons and holes are recombined at the luminescent center to bring organic molecules into an excited state. These organic molecules emit fluorescent light when they return to a ground state from their excited state.

The organic EL devices are capable of emitting a variety of colors depending on the selection of fluorescent materials as luminescent materials, which makes them increasingly promising for applications in display apparatuses such as multi-color and full-color displays. Since organic EL devices are capable of surface emission at low voltage, they can also be used as the backlights for liquid crystal displays or the like. At present, applications of the organic EL devices in small displays such as digital cameras and mobile telephones are being developed.

An organic EL device is extremely sensitive to moisture; specifically, the interface between a metal electrode and an organic layer may deteriorate by the influence of moisture, an electrode may be removed, a metal electrode may be oxidized to increase the resistance, or an organic material itself may deteriorate by the moisture. Such phenomena lead to a rise in the drive voltage, the generation and growth of dark spots (non-luminescent defects) or reduced luminance, which cause the loss of sufficient reliability.

Thus, preventing the invasion of moisture is essential to maintain sufficient reliability of an organic EL device. For this problem, the structure shown in FIG. 17 is used in order to prevent the invasion of moisture. FIG. 17 is a schematic cross section of a conventional organic EL apparatus.

In FIG. 17, a plurality of organic EL devices 50 are arranged on a substrate 1. Each organic EL device 50 includes, in order, a hole injection electrode, a hole injection layer, a hole transport layer, a light emitting layer, an electron transport layer, an electron injection layer, and an electron injection electrode. Only the hole injection electrode 2 is illustrated in FIG. 17.

In the conventional organic EL apparatus, a sealing agent 11 is applied on the outer periphery of the substrate 1, and a glass or metal sealing can 20J having a desiccant 31 inside is covered on the substrate 1 so as to cover the plurality of organic EL devices 50. The metal sealing can 20J is bonded onto the substrate 1 by curing the sealing agent 11 with ultraviolet light or heat. The organic EL devices 50 are thus shielded from outside air.

With the organic EL apparatus 900 in FIG. 17, however, foam may be generated inside the sealing agent 11 during the fabrication. In that case, the invasion of moisture to the organic EL devices 50 cannot be sufficiently prevented.

Moreover, in the organic EL apparatus 900 of FIG. 17, the sealing can 20J is used for sealing the organic EL devices 50. In consideration of the expansion of the desiccant 31 due to moisture, for example, spacing must be provided between the organic EL devices 50 inside the sealing can 20J and the desiccant 31. The thickness of the sealing can 20J thus increases, which makes thinning of the organic EL apparatus 900 difficult.

In one suggested organic EL device structure, a photo-curing resin layer with moisture resistance is formed so as to cover the organic EL layers, and a non-permeable small substrate is fixed on top of the photo-curing resin layer (refer to JP 5-182759 A).

With the organic EL device structure, the organic EL device is shielded from outside air with the moisture resistant photo-curing layer and the non-permeable substrate, making the organic EL device thinner.

However, when a filler such as silica or glass is added to the photo-curing resin layer for lowering the permeability, the viscosity of the photo-curing resin layer increases, and the photo-curing resin layer is whitened.

An increase in the viscosity of the photo-curing resin layer makes it difficult to make the thickness of the photo-curing resin layer uniform while increasing the area of the organic EL device. For a structure whereby light is extracted outside through an upper surface of the photo-curing rein layer, it is difficult to extract a sufficient amount of light produced from the organic EL layers.

Moreover, during lamination of the photo-curing resin layer to the non-permeable substrate, foam is very likely to enter the interface between them.

On the other hand, a method for preventing the generation of foam during the lamination of a substrate is proposed (refer to JP 2002-110349 A). In this method, a sealing agent such as an ultraviolet curing resin is provided on a pixel panel, and a cover glass reinforced with a reinforcement sheet is arranged on the sealing agent, followed by the lamination of the cover glass with the sealing agent by applying a pressing force with a roller.

Although in this method, residual foam is prevented by the pressing force of the roller, a shift in the position and a deformation of the cover glass to a saddle shape may occur, which makes it difficult to laminate the cover glass in uniform thickness.

In addition to the aforementioned method, a method is proposed for preventing foam generated in a sealing material for use in sealing electroluminescent devices (refer to JP 2001-284043 A). In this method, electroluminescent devices arranged on a glass substrate are covered with an edge adhesive and a glass lid plate with some openings being provided therein. Then, a hollow portion formed by the edge adhesive and the glass lid plate is filled with a sealing material through the openings using a vacuum chamber, and the sealing material is cured in the atmosphere.

In this method, the sealing material injected into the hollow portion that covers the electroluminescent devices is charged in a vacuum, so that the generation of foam is prevented. However, because the sealing material is cured under atmospheric pressure, foam may be generated through the openings in the hollow portion.

### DISCLOSURE OF INVENTION

An object of the present invention is to provide a method of fabricating an organic electroluminescent apparatus that is thinner and capable of sealing organic electroluminescent devices in uniform thickness without the inclusion of foam.

Another object of the present invention is to provide a thinner organic electroluminescent apparatus.

Still another object of the present invention is to provide an organic electroluminescent apparatus that is thinner and sufficiently prevented from the invasion of moisture.

Yet another object of the present invention is to provide an organic electroluminescent apparatus that is thinner, having uniform thickness, and sufficiently prevented from the invasion of moisture.

A method of fabricating an organic electroluminescent apparatus according to one aspect of the present invention comprises the steps of forming one or a plurality of organic electroluminescent devices on a substrate, providing one or more kinds of sealing agents for sealing the one or plurality of organic electroluminescent devices on at least one of the substrate and a sealing plate, laminating the substrate and the sealing plate through the sealing agent under a reduced pressure, and placing the substrate and the sealing plate laminated through the sealing agent in the atmosphere to cure the sealing agent.

In the method of fabricating the organic electroluminescent apparatus, the one or plurality of organic electroluminescent devices are formed on the substrate, and the one or more kinds of sealing agents are provided on at least one of the substrate and the sealing plate. Next, the substrate and the sealing plate are laminated through the sealing agent under a reduced pressure. The substrate and sealing plate laminated with each other are subsequently placed in the atmosphere, so that the sealing agent is cured.

In this case, the substrate and the sealing plate are laminated under a reduced pressure, which prevents the generation of foam inside the sealing agent.

Moreover, after the lamination of the substrate and the sealing plate through the sealing agent under a reduced pressure, the laminated substrate is placed in the atmosphere. This causes the sealing agent charged between the organic electroluminescent devices on the substrate and the sealing plate to be subjected to an external uniform pressure. The substrate and the sealing plate are thus laminated in uniform thickness.

In addition, the one or plurality of organic electroluminescent devices formed on the substrate are laminated with the sealing plate through the sealing agent, which makes the organic electroluminescent apparatus thinner than organic electroluminescent apparatuses using sealing cans to seal the organic electroluminescent devices.

The one or more kinds of sealing agents may include a first sealing agent of one kind and a second sealing agent of another kind, the first sealing agent having a lower viscosity than that of the second sealing agent, the first sealing agent being provided so as to seal the one or plurality of organic electroluminescent devices on the substrate, the second sealing agent being provided on an outer peripheral portion on the substrate so as to surround the one or plurality of organic electroluminescent devices.

In this case, the first and second sealing agents are subjected to atmospheric pressure from the outside toward the inside during curing, which prevents leakage of the first sealing agent with a lower viscosity than that of the second sealing agent to the outside.

Moreover, since the second sealing agent has a higher viscosity than that of the first sealing agent, the second sealing agent before curing has higher shape retention than that of the first sealing agent, preventing the invasion of the second sealing agent to the first sealing agent to reduce the height. This prevents direct contact of the organic electroluminescent devices with the sealing plate during the lamination of the substrate and the sealing plate.

An organic electroluminescent apparatus according to another aspect of the present invention comprises a substrate, one or a plurality of organic electroluminescent devices arranged on the substrate, and a plurality of kinds of sealing agents for sealing the one or plurality of organic electroluminescent devices, wherein a first sealing agent of one kind of the plurality of kinds of sealing agents seals the one or plurality of organic electroluminescent devices, and a second sealing agent of another kind of the plurality of kinds of sealing agents seals an outer peripheral portion on the substrate so as to surround the one or plurality of organic electroluminescent devices.

In this case, the first sealing agent of one kind of the plurality of kinds of sealing agents seals the one or plurality of organic electroluminescent devices arranged on the substrate, and the second sealing agent of the other kind seals the outer peripheral portion on the substrate so as to surround the one or plurality of organic electroluminescent devices. This allows the organic electroluminescent apparatus to be thinner than those using sealing cans to seal the organic electroluminescent devices.

The first sealing agent may have a lower viscosity than that of the second sealing agent. This facilitates spreading of the first sealing agent with a lower viscosity over the entire one or plurality of organic electroluminescent devices, thus making the fabrication easier. Moreover, since the second sealing agent has a higher viscosity than that of the first sealing agent, the second sealing agent before curing is prevented from invading the first sealing agent to reduce the height.

A filler may be added to the first sealing agent. The addition of a filler to the first sealing agent improves the moisture resistance of the first sealing agent. This prevents the invasion of moisture to the organic electroluminescent devices sufficiently.

A desiccant may be added to the first sealing agent. The addition of a desiccant to the first sealing agent allows the absorption of moisture contained in the first sealing agent. This prevents the invasion of moisture to the organic electroluminescent device sufficiently.

The first sealing agent may be an adhesive. This allows the one or plurality of organic electroluminescent devices on the substrate to be sealed by the curing of the adhesive.

The first sealing agent may be an adhesive in sheet form. The solid first sealing agent is easier to handle than adhesives with low viscosities. Moreover, a constant thickness possessed by the solid first sealing agent per se improves thickness uniformity of the organic electroluminescent apparatus.

A filler may be added to the second sealing agent. The addition of a filler to the second sealing agent improves the moisture resistance of the second sealing agent. This prevents the invasion of moisture to the organic electroluminescent device sufficiently.

A desiccant may be added to the second sealing agent. The addition of a desiccant to the second sealing agent allows the absorption of moisture contained in the second sealing agent by the desiccant. This prevents the invasion of moisture to the organic electroluminescent device sufficiently.

The second sealing agent may be in contact with the one or plurality of organic electroluminescent devices. The contact of the second sealing agent with the one or plurality of organic electroluminescent devices allows a broad region of the outer peripheral portion on the substrate to be sealed with the second sealing agent. This prevents the invasion of moisture to the organic electroluminescent device more sufficiently without spreading the non-luminescent area on the outer peripheral portion on the substrate.

The substrate may be laminated with a sealing plate through the plurality of kinds of sealing agents. This allows the one or plurality of organic electroluminescent devices on the substrate to be sealed with the plurality of kinds of sealing agents while preventing the invasion of moisture to the organic electroluminescent devices that are sealed with the sealing plate.

When the first sealing agent is an adhesive in sheet form, the adhesive in sheet form can be applied beforehand on the sealing plate, so that the fabrication process is simplified.

A storage portion for storing a desiccant may be provided on a surface of the sealing plate opposite to the substrate. Since the storage portion for storing a desiccant is provided on the surface of the sealing plate, the desiccant absorbs the moisture contained in the plurality of kinds of sealing agents for sealing the one or plurality of organic electroluminescent devices. This prevents the invasion of moisture to the organic electroluminescent devices even more sufficiently.

The sealing plate may be made of an optically transparent material, and a color filter may be provided on the surface of the sealing plate opposite to the substrate. As used in the specification the term “color filter” includes a CCM (Color Conversion Medium). In this case, light produced from the organic electroluminescent devices formed on the substrate is extracted outside through the color filter and the sealing plate. This results in an organic electroluminescent apparatus having a top emission structure.

The one or plurality of organic electroluminescent devices may be covered with a passivation layer comprising a single layer or a plurality of layers. The covering of the organic electroluminescent devices with the passivation layer comprising a single or a plurality of non-permeable layers prevents the invasion of moisture to the organic electroluminescent devices sufficiently.

An organic electroluminescent apparatus according to still another aspect of the present invention comprises a substrate, one or a plurality of organic electroluminescent devices arranged on the substrate, a sealing agent for sealing the one or plurality of organic electroluminescent devices on the substrate, and a sealing plate laminated to the substrate through the sealing agent, wherein an outer peripheral surface of the sealing agent between the substrate and the sealing plate is formed in a concave shape.

In the organic electroluminescent apparatus, the outer peripheral surface of the sealing agent is formed in a concave shape, since the sealing agent between the substrate and the sealing plate is subjected to pressure from the outside toward the inside during the fabrication. This allows the sealing agent to be densely formed without the inclusion of foam. This prevents the invasion of moisture to the organic electroluminescent device sufficiently.

Moreover, the sealing agent is prevented from spreading outside and adhering to terminals that extend outside of the organic electroluminescent device, so that the process of removing the sealing agent adhering on the terminals is omitted.

### BRIEF DESCRIPTION OF DRAWINGS

FIG. 1 (a) is a schematic cross section of an organic EL apparatus according to a first embodiment, and FIG. 1 (b) is a magnified view of a portion of the organic EL apparatus of FIG. 1 (a);

FIG. 2 is a schematic cross section of an organic EL apparatus according to a second embodiment;

FIG. 3 is a schematic cross section of an organic EL apparatus according to a seventh embodiment;

FIG. 4 is a schematic cross section of an organic EL apparatus according to an eighth embodiment;

FIG. 5 is a schematic cross section of an organic EL apparatus according to a ninth embodiment;

FIG. 6 is a schematic cross section showing the sealing structure of an organic EL device according to Inventive Example 1;

FIG. 7 is a schematic cross section showing the sealing structure of an organic EL device according to Inventive Example 2;

FIG. 8 is a schematic cross section showing the sealing structure of an organic EL device according to Inventive Example 3;

FIG. 9 is a schematic cross section showing the sealing structure of an organic EL device according to Inventive Example 4;

FIG. 10 is a schematic cross section showing the sealing structure of an organic EL device according to Inventive Example 5;

FIG. 11 is a schematic cross section showing the sealing structure of an organic EL device according to Inventive Example 6;

FIG. 12 is a schematic cross section showing the sealing structure of an organic EL device according to Inventive Example 7;

FIG. 13 is a schematic cross section showing the sealing structure of an organic EL device according to Inventive Example 8;

FIG. 14 is a schematic cross section showing the sealing structure of an organic EL device according to Inventive Example 9;

FIG. 15 is a schematic cross section showing the sealing structure of an organic EL device according to Comparative Example;

FIG. 16 is a graph showing the results of high temperature and high humidity tests on the organic EL devices sealed in Comparative Example and Inventive Examples 1 to 9; and

FIG. 17 is a schematic cross section of a conventional organic EL apparatus.

### BEST MODE FOR CARRYING OUT THE INVENTION

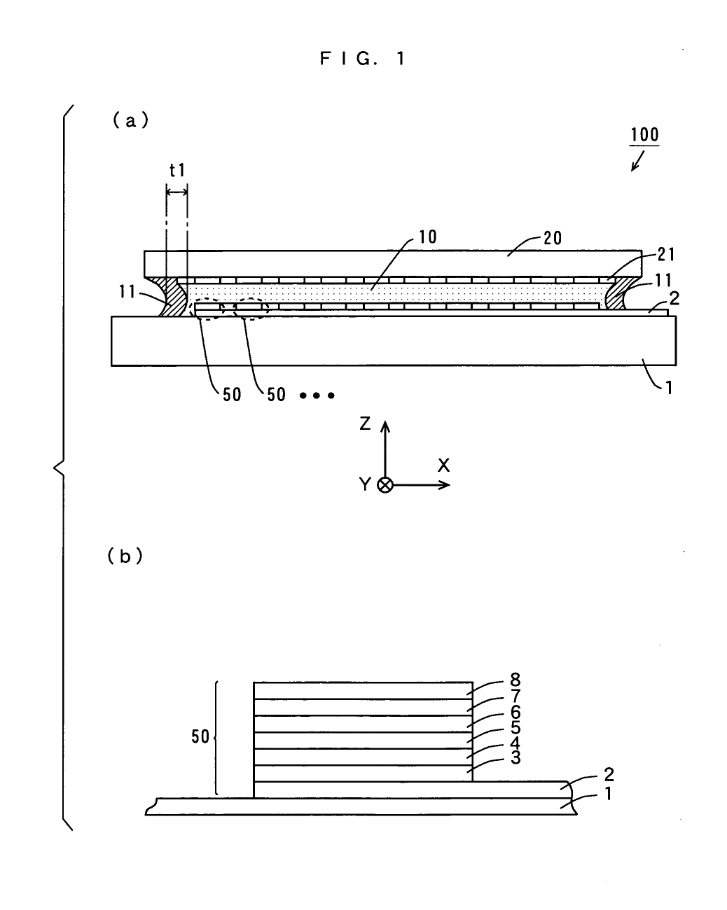

Organic electroluminescent (hereinafter abbreviated to organic EL) apparatuses according to first to ninth embodiments and methods for manufacturing these apparatuses will be described below with reference to FIG. 1 to FIG. 5.

### First Embodiment

FIG. 1 (a) is a schematic cross section of an organic EL apparatus according to a first embodiment, and FIG. 1 (b) is a magnified view of a portion of the organic EL apparatus of FIG. 1 (a). The organic EL apparatus 100 in the first embodiment has a top emission structure whereby light is extracted through an upper surface side.

In the organic EL apparatus 100 of FIG. 1 (a), a plurality of organic EL devices 50 are arranged in matrix form on a substrate 1. Each organic EL device 50 forms a pixel. For a passive matrix type, a glass substrate is used as the substrate 1, and for an active matrix type, a TFT substrate made of a glass substrate having a plurality of TFTs (Thin Film Transistors) and planarization layers thereon is used as the substrate 1.

Three directions perpendicular to one another are herein defined as X, Y, and Z directions, respectively. The X and Y directions are parallel to a surface of the substrate 1, and the Z direction is vertical to the surface of the substrate 1. The plurality of organic EL devices 50 are arranged along the X and Y directions.

As shown in FIG. 1 (b), an organic EL device 50 has a laminated structure that includes a hole injection electrode 2, a hole injection layer 3, a hole transport layer 4, a light emitting layer 5, an electron transport layer 6, an electron injection layer 7, and an electron injection electrode 8. The hole injection electrode 2 is arranged continuously or for each pixel along the X direction, and the electron injection electrode 8 is arranged along the Y direction. Adjacent organic EL devices 50 are separated by a device separating insulating layer that is made of a resist material.

The hole injection electrode 2 is a transparent, a semi-transparent, or an opaque electrode made of a metal compound such as ITO (Indium-Tin Oxide), a metal such as Ag (silver), or an alloy. The electron injection electrode 8 is a transparent electrode made of a metal compound such as ITO, a metal, or an alloy. The hole injection layer 3, hole transport layer 4, light emitting layer 5, electron transport layer 6, and electron injection layer 7 each comprise an organic material.

In FIG. 1 (a), a sealing agent 10 is formed over the plurality of organic EL devices 50 on the substrate 1, and a sealing agent 11 is formed over an outer peripheral portion on the substrate 1 so as to surround the entire perimeter of the plurality of organic EL devices 50. A sealing plate 20 is bonded on the upper surface side of the sealing agent 10 with a color filter 21 inserted therebetween. The color filter 21 is formed integrally with the sealing plate 20. The sealing plate 20 and the color filter 21 are each made of a transparent material such as glass or plastic. For example, a CCM (Color Conversion Medium) described in JP 2002-299055 A may be used as the color filter 21.

As described above, in this embodiment, the sealing agent 10 is formed so as to surround the plurality of organic EL devices 50, and the sealing agent 11 is formed so as to surround the outer periphery of the sealing agent 10. In other words, the outer periphery of the plurality of organic EL devices 50 is covered by the two sealing agents 10, 11. The sealing agent 11 has a width t1 of about 1 to 5 mm.

When a drive voltage is applied across the organic EL device 50, i.e., between the hole injection electrode 2 and the electron injection electrode 8, the light emitting layer 5 emits light. The light produced from the light emitting layer 5 is extracted outside through the electron injection electrode 8, sealing agent 10, color filter 21, and sealing plate 20.

The sealing agents 10, 11 used in the organic EL device 100 are described. In this embodiment, the viscosity of the sealing agent 11 is adjusted to be higher than that of the sealing agent 10. The viscosities of the sealing agents 10, 11 are determined by the kinds of materials used as well as the kinds of additives such as fillers or desiccants added to the respective sealing agents 10, 11, and the amounts of addition thereof.

Each of the sealing agents 10, 11 is made of a ultraviolet (UV) curing type, visible light curing type, thermosetting type, complex curing type using UV light and heat, or delayed curing type using UV light, resin or adhesive, for example.

More specifically, the sealing agent 10 may include thermosetting resins such as urea resins, melamine resins, phenol resins, resorcinol resins, epoxy resins, unsaturated polyester resins, polyurethane resins, or acrylic resins; thermoplastic resins such as vinyl acetate resins, ethylene-vinyl acetate copolymer resins, acrylic resins, cyanoacrylate resins, polyvinyl alcohol resins, polyamide resins, polyolefin resins, thermoplastic polyurethane resins, saturated polyester resins, or cellulose resins; radical-based photo-curing adhesives using resins such as a variety of acrylates such as ester acrylates, urethane acrylates, epoxy acrylates, melamine acrylates or acrylic resin acrylates or urethane polyesters; cationic photo-curing adhesives using resins such as epoxy or vinyl ethers; thiol-en added resin-based adhesives; synthesized polymer adhesives based on such rubbers as chloroprene rubber, nitrile rubber, styrene-butadiene rubber, natural rubber, butyl rubber or silicone rubber, or synthesized polymer adhesives such as vinyl-phenolic, chloroprene-phenolic, nitrile-phenolic, nylon-phenolic, or epoxy phenolic.

For the sealing agent 11, any of the above-mentioned materials for use as the sealing agent 10 is used with the addition of a filler.

The filler that is added to the sealing agent 11 is made of an inorganic material such as SiO (silicon oxide), SiON (silicon nitride oxide), or SiN (silicon nitride) or a metal material such as Ag, Ni (nickel), or Al (aluminum). The addition of a filler to the sealing agent 11 results in improved viscosity and moisture resistance over those of a material used itself.

The sealing agent 10 preferably has a transmittance of about 30% or more for the visible light with wavelengths of about 400 nm to about 800 nm, more preferably a transmittance of about 70% or more.

A method of fabricating an organic EL apparatus 100 in this embodiment is now described.

A plurality of organic EL devices 50 are formed first on a substrate 1. Next, a film of the sealing agent 11 containing a filler is uniformly formed by screen printing on the outer periphery of a lower surface (on the color filter 21 side) of a sealing plate 20 that is formed integrally with a color filter 21. Alternatively, the sealing agent 11 may be applied uniformly on the outer periphery of the sealing plate 20 using a dispenser. Still alternatively, a film of the sealing agent 11 may be formed or the sealing agent 11 may be applied not on the outer periphery of the lower surface of the sealing plate 20 but on the outer periphery of the upper surface of the substrate 1.

Then, a sealing agent 10 is dropped onto a central portion of the sealing plate 20. Small amounts of the sealing agent 10 may be dropped a number of times over an entire surface of the sealing plate 20. This facilitates spreading of the sealing agent 10 over the entire surface of the sealing plate 20, so that the lamination of the substrate 1 and the sealing plate 20 described below is accomplished in a short time.

After that, the sealing plate 20 and the substrate 1 are laminated in a vacuum chamber. Each of the sealing plate 20 and the substrate 1 having the plurality of organic EL devices thereon is first mounted on a substrate holder in the vacuum chamber that is left open under atmospheric pressure. The vacuum chamber is hermetically sealed in this state, with the pressure in the vacuum chamber being reduced to a predetermined degree of vacuum. The inside of the vacuum chamber is thus in a vacuum.

Next, the sealing plate 20 and the substrate 1 are positioned opposite to each other by the manipulation of the substrate holder in the vacuum chamber in a vacuum, so that the sealing plate 20 and the substrate 1 are overlaid with each other. Then, the positions of the sealing plate 20 and the substrate 1 are again adjusted before the sealing plate 20 and the substrate 1 were laminated with a predetermined pressure.

After the lamination of the sealing plate 20 and the substrate 1, the vacuum chamber is released from its vacuum state, and the substrate 1 and sealing plate 20 laminated with each other are removed from the vacuum chamber. Finally, the sealing agents 10, 11 between the substrate 1 and the sealing plate 20 are cured by the curing methods suitable for the respective materials. The organic EL apparatus 100 is thus completed.

In the above-described method of fabrication, the substrate 1 and the sealing plate 20 of the organic EL apparatus 100 are laminated in a vacuum in the vacuum chamber, which prevents the generation of foam inside the sealing agents 10, 11.

Moreover, the process of curing the sealing agents 10, 11 is performed in atmospheric pressure after the lamination of the substrate 1 and the sealing plate 20 in a vacuum using the sealing agents 10, 11. The sealing agents 10, 11 before curing are thus subjected to atmospheric pressure from the outside toward the inside, causing a deformation of the outer peripheral surface of the sealing agent 11 to a concave shape, as shown in FIG. 1 (a). Then, the sealing agents 10, 11 are cured in this state.

The exposure of the sealing agents 10, 11 to atmospheric pressure from the outside toward the inside prevents leakage of the sealing agent 10 having a lower viscosity to the outside. As a result, the sealing agent 10 is prevented from adhering to electrode terminals that extend from the hole injection electrode 2 outside of the sealing agent 11.

In addition, the sealing agent 10 with a lower viscosity is being charged between the organic EL devices 50 on the substrate 1 and the sealing plate 20. The sealing agent 10 over the organic EL devices 50 is then placed in the atmosphere, and subjected to an external uniform pressure through the sealing plate 20. This facilitates spreading of the sealing agent 10 on the entire surface during the lamination of the substrate 1 and the sealing plate 20, resulting in the lamination of the substrate 1 and the sealing plate 20 in uniform thickness.

Moreover, the sealing plate 20 is laminated onto the plurality of organic EL devices 50 formed on the substrate 1 through the sealing agents 10, 11, resulting in the organic EL apparatus 100 thinner than the apparatus of FIG. 17 covered with the sealing can 20J.

In addition, the addition of a filler to the sealing agent 11 results in improved viscosity and moisture resistance over those of the material used itself. Thus, the outer periphery of the sealing agent 10 that seals the organic EL devices 50 is surrounded with the sealing agent 11 having a higher viscosity and higher moisture resistance, while the upper surface side of the sealing agent 10 is covered with the non-permeable sealing plate 20. This sufficiently prevents the invasion of moisture to the organic EL devices 50.

Moreover, since the viscosity of the sealing agent 11 is higher than that of the sealing agent 10, the sealing agent 11 before curing has higher shape retention that of the sealing agent 10, which prevents the invasion of sealing agent 11 into the sealing agent 10 to reduce the height. This prevents direct contact of the organic EL devices 50 to the sealing plate 20 during the lamination of the substrate 1 and the sealing plate 20.

Moreover, since a filler that is responsible for whitening is not added to the sealing agent 10, light produced from the organic EL devices 50 can be sufficiently extracted outside through the sealing agent 10.

When the same materials are used for the sealing materials 10, 11, the effects described above are attained with the addition of a filler to the sealing agent 11, thus allowing lower material cost.

Note that during the lamination of the substrate 1 and the sealing plate 20 in the fabrication of the above-described organic EL apparatus 100, if entire surfaces of the substrate 1 and the sealing plate 20 are subjected to atmospheric pressure, the substrate 1 and the sealing plate 20 are pressed against each other, which may make the deformation of the outer peripheral surface of the sealing agent 11 to a concave shape difficult. For this reason, in order to deform the outer peripheral surface of the sealing agent 11 to a concave shape, a plurality of spacers with a predetermined height may be arranged beforehand between the substrate 1 and the sealing plate 20. When the plurality of spacers are equally spaced between the substrate 1 and the sealing plate 20, the space between the substrate 1 and the sealing plate 20 is maintained with the plurality of spacers even if the entire surfaces of the substrate 1 and the sealing plate 20 are subjected to atmospheric pressure. This results in the deformation of the outer peripheral surface of the sealing agent 11 to a concave shape due to atmospheric pressure.

In this embodiment, even if the outer peripheral surface of the sealing agent 11 fails to deform to a concave shape (for example, without deformation or with a convex deformation), similar effects to those described above can be attained; i.e., the lamination of the substrate 1 and the sealing plate 20 in uniform thickness, thinner organic EL apparatus 100, and prevention of the invasion of moisture to the organic EL devices 50.

The sealing structure of the organic EL devices 50 in this embodiment is also applicable to a back emission structure whereby light produced from organic EL devices 50 is extracted through a rear surface side of a substrate 1.

An organic EL apparatus with the back emission structure employs a transparent electrode of a metal compound such as ITO, a metal, or an alloy for the hole injection electrode 2, and employs a transparent, semi-transparent, or opaque electrode of a metal compound such as ITO, a metal, or an alloy for the electron injection electrode 8. The color filter 21 is arranged on the rear surface of the substrate 1 or between the substrate 1 and the hole injection electrode 2.

### Second Embodiment

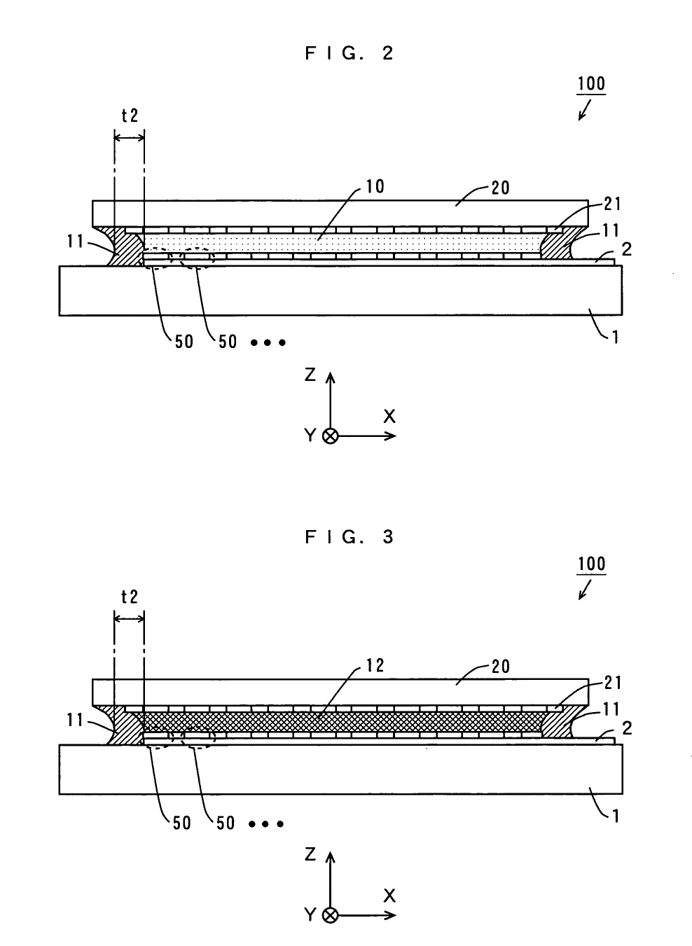

FIG. 2 is a schematic cross section of an organic EL apparatus according to a second embodiment. The organic EL apparatus 100 in the second embodiment is configured similarly to the organic EL apparatus 100 in the first embodiment, and fabricated by a similar method to that of the first embodiment except the following.

The width t2 of a sealing agent 11 over the outer peripheral portion on the substrate 1 (the dimension parallel to a surface of the substrate 1) is formed to have a thickness greater than that of the width t1 (about 1 to 5 mm) of the sealing agent 11 in the first embodiment. The width t2 of the sealing agent 11 is about 2 to 10 mm. In this embodiment, the sealing agent 11 is formed so as to surround the plurality of organic EL devices 50. In other words, the outer periphery of the portion on the substrate 1 is covered by the single layer of sealing agent 11, with the sealing agent 11 being in contact with the organic EL devices 50 on the outer periphery. This prevents the invasion of moisture to the organic EL devices 50 more sufficiently without spreading non-luminescent areas on the periphery of the portion on the substrate 1.

### Third Embodiment

An organic EL apparatus 100 according to a third embodiment is configured similarly to that of FIG. 2, and fabricated by a similar method to that of the first embodiment except the following.

A material containing a filler and a desiccant is used for a sealing agent 11 over the outer peripheral portion on the substrate 1. The desiccant added to the sealing agent 11 includes chemical absorbents such as calcium oxide, calcium sulfate, calcium chloride, barium oxide, and strontium oxide or physical absorbents such as activated carbon, silica gel, and zeolite. A material mentioned in the first embodiment is used for the sealing agent 11.

The addition of a desiccant to the sealing agent 11 allows the absorption of moisture contained in the sealing agent 11. This prevents the invasion of moisture to organic EL devices 50 still more sufficiently.

### Fourth Embodiment

An organic EL apparatus 100 according to a fourth embodiment is configured similarly to that of FIG. 2, and fabricated by a similar method to that of the first embodiment except the following.

A material containing a filler is used as a sealing agent 10 for sealing organic EL devices 50 on a substrate 1. A filler described in the first embodiment to be added to the sealing agent 11 is used for the filler added to the sealing agent 10. It is desired that the content of the filler added to the sealing agent 10 is much lower than that of a filler added to a sealing agent 11.

The addition of a filler to the sealing agent 10 improves the moisture resistance of the sealing agent 10. This prevents the invasion of moisture to organic EL devices 50 even more sufficiently.

A very low content of the filler added to the sealing agent 10 reduces whitening due to the addition of the filler, thus allowing a sufficient extraction of light produced from the organic EL devices 50 outside through the sealing agent 10. Increases in the viscosity are also reduced, so that the sealing agent 10 easily spreads entirely during the lamination of a substrate 1 and a sealing plate 20, resulting in lamination of the substrate 1 and the sealing plate 20 in uniform thickness.

It is desired that the refractive index of the filler added to the sealing agent 10 is ±10% or less of the refractive index of the sealing agent 10. When a 70% or more transmittance of the sealing agent 10 is ensured by making the amount of added filler small, it is not necessary to control the refractive index of the filler.

In this embodiment, the sealing agent 10 containing the filler preferably has a transmittance of about 30% or more for the visible light with wavelengths of about 400 nm to about 800 nm, more preferably a transmittance of about 70% or more.

### Fifth Embodiment

An organic EL apparatus 100 according to a fifth embodiment is configured similarly to that of FIG. 2, and fabricated by a similar method to that of the first embodiment except the following.

A material containing a filler is used as a sealing agent 10 for sealing organic EL devices 50 on a substrate 1. A filler described in the first embodiment to be added to the sealing agent 11 is used as the filler added to the sealing agent 10. It is desired that the content of the filler added to the sealing agent 10 is much lower than that of a filler added to a sealing agent 11.

In this embodiment, the sealing agent 10 containing the filler preferably has a transmittance of about 30% or more for the visible light with wavelengths of about 400 nm to about 800 nm, more preferably a transmittance of about 70% or more.

A material containing a filler and a desiccant is used for the sealing agent 11 over the outer periphery on a portion on the substrate 1. A desiccant described in the third embodiment is used as the desiccant added to the sealing agent 11. A material described in the first embodiment is used as the material of the sealing agent 11.

The addition of a filler to each of the sealing agents 10, 11 improves the moisture resistance of each of the sealing agents 10, 11, while the addition of a desiccant to the sealing agent 11 allows the absorption of moisture contained in the sealing agent 11 by the desiccant. This prevents the invasion of moisture to the organic EL devices 50 still more sufficiently.

A very low content of the filler added to the sealing agent 10 reduces whitening due to the addition of the filler, thus allowing a sufficient extraction of light produced from the organic EL devices 50 outside through the sealing agent 10. Increases in the viscosity are also reduced, so that the sealing agent 10 easily spreads entirely during the lamination of the substrate 1 and a sealing plate 20, resulting in lamination of the substrate 1 and the sealing plate 20 in uniform thickness.

### Sixth Embodiment

An organic EL apparatus 100 according to a sixth embodiment is configured similarly to that of FIG. 2, and fabricated by a similar method to that of the first embodiment except the following.

Materials containing a filler and a desiccant are used as a sealing agent 10 for sealing organic EL devices 50 on a substrate 1 and a sealing agent 11 on the outer peripheral portion on the substrate 1, respectively.

For the fillers added to the respective sealing agents 10, 11, fillers described in the first embodiment are used, and for the desiccants, desiccants described in the third embodiment are used. It is desired that the content of the filler added to the sealing agent 10 is much lower than that of the filler added to the sealing agent 11.

In this embodiment, the sealing agent 10 containing a filler and a desiccant preferably has a transmittance of about 30% or more for the visible light with wavelengths of about 400 nm to about 800 nm, more preferably a transmittance of about 70% or more.

The addition of fillers to the sealing agents 10, 11 improves the moisture resistance of the sealing agent 10, while the addition of desiccants to the sealing agents 10, 11 allows the absorption of moisture contained in the sealing agents 10, 11 by the respective desiccants. This prevents the invasion of moisture to the organic EL devices 50 even more sufficiently.

A very low content of the filler added to the sealing agent 10 reduces whitening due to the addition of the filler, thus allowing a sufficient extraction of light produced from the organic EL devices 50 outside through the sealing agent 10. Increases in the viscosity are also reduced, so that the sealing agent 10 easily spreads entirely during the lamination of the substrate 1 and a sealing plate 20, resulting in lamination of the substrate 1 and the sealing plate 20 in uniform thickness.

### Seventh Embodiment

FIG. 3 is a schematic cross section of an organic EL apparatus according to a seventh embodiment. The organic EL apparatus 100 in the seventh embodiment is configured similarly to that of FIG. 2, and fabricated by a similar method to that of the first embodiment except the following.

In this embodiment, a sealing agent 12 is used instead of the sealing agent 10 for use in the second embodiment. More specifically, an adhesive (adhesive sheet) based on such rubbers as chloroprene rubber, nitrile rubber, styrene-butadiene rubber, natural rubber, butyl rubber or silicone rubber is used as the sealing agent 12.

In the fabrication of the organic EL apparatus 100, the sealing agent 12 is applied beforehand on a central portion of a lower surface of a sealing plate 20 (position on a plurality of organic EL devices 50 upon lamination) that is formed integrally with a color filter 21. In this case, after the film formation or application of a sealing agent 11, the sealing plate 20 and the substrate 1 are laminated in a vacuum chamber.

The lamination of the sealing agent 12 to the sealing plate 20 may be followed by the film formation of the sealing agent 11 containing a filler by screen printing or the application of the sealing agent 11 by a dispenser.

Since the sealing agent 12 is a solid, the sealing agent 12 is easier to handle than a sealing agent with low viscosity. Moreover, the solid sealing agent 12 per se has a constant thickness, so that the substrate 1 and the sealing plate 20 are laminated in uniform thickness, resulting in improved thickness uniformity. In addition, the sealing agent 12 can be applied beforehand on the sealing plate 20, so that the fabrication process is simplified.

In this embodiment, the sealing agent 12 preferably has a transmittance of about 30% or more for the visible light with wavelengths of about 400 nm to about 800 nm, more preferably a transmittance of about 70% or more.

In this embodiment, the sealing agent 11 for use in any of the foregoing second embodiment to fifth embodiment is used as the sealing agent 11, providing similar effects to those described above.

### Eighth Embodiment

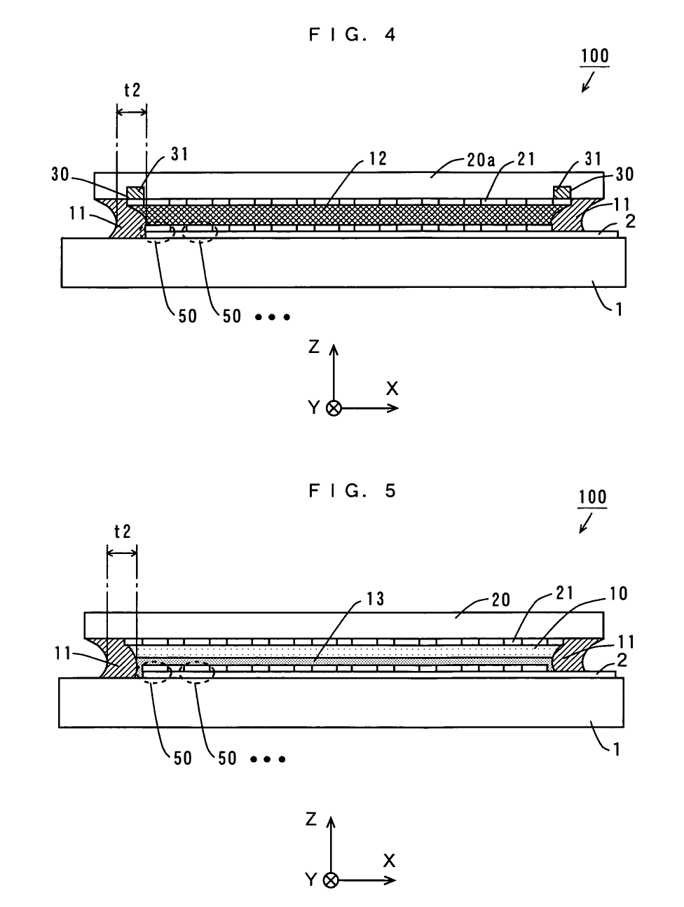

FIG. 4 is a schematic cross section of an organic EL apparatus according to an eighth embodiment. The organic EL apparatus 100 in the eighth embodiment is configured similarly to that of FIG. 3, and fabricated by a similar method to that of the seventh embodiment except the following.

In this embodiment, a sealing plate 20a provided with a groove 30 near an outer periphery is used instead of the sealing plate 20 for use in the seventh embodiment. A desiccant 31 is stored in the groove 30.

In the fabrication of the organic EL apparatus 100, the groove 30 is formed beforehand near the outer periphery of a lower surface of a sealing plate 20 that is formed integrally with a color filter 21, and the desiccant 31 is stored in the groove 30. The desiccant 31 has a liquid or a solid (sheet) form; more specifically, a material mentioned in the third embodiment is used as the desiccant 31. The groove 30 is formed in a position that is covered with a sealing agent 12.

The storage of the desiccant 31 in the groove 30 near the outer periphery of the lower surface of the sealing plate 21 allows the absorption of moisture contained in the sealing agent 12. This prevents the invasion of moisture to organic EL devices 50 even more sufficiently.

Moreover, the covering of the groove 30 with the sealing agent 12 prevents contact of the desiccant 31 and the sealing agent 11 to react. In addition, even if the volume of the desiccant 31 expands by moisture absorption, the storage of the desiccant 31 in the groove 30 of the sealing plate 20 prevents degradation in adhesion due to a stress being applied to the sealing agent 12.

In this embodiment, the sealing agent 11 for use in any of the foregoing second embodiment to fifth embodiment is used as the sealing agent 11, providing similar effects to those described above.

### Ninth Embodiment

FIG. 5 is a schematic cross section of an organic EL apparatus according to a ninth embodiment. The organic EL apparatus 100 in the ninth embodiment is configured similarly to that of FIG. 2, and fabricated by a similar method to that of the first embodiment except the following.

In this embodiment, a passivation layer 13 is formed on upper surfaces and side surfaces of organic EL devices 50. A single- or multi-layer film comprising inorganic films such as SiO, SiON or SiN or polymeric films such as parylene is used as the passivation layer 13.

In the fabrication of the organic EL apparatus 100, the organic EL devices 50 are formed on a substrate 1, and the passivation layer 13 is subsequently formed on the upper and side surfaces of the organic EL devices 50 using a variety of deposition techniques such as vacuum-deposition, CVD (Chemical Vapor Deposition) or sputtering. Then, the substrate 1 and a sealing plate 20 are laminated through the sealing agents 10, 11 same as those in the sixth embodiment, so as to seal the organic EL devices 50.

In this case, the non-permeable passivation layer 13 is formed over the organic EL devices 50, which prevents the invasion of moisture to the organic EL devices 50 still more sufficiently. Note that the use of sealing agent 12 for use in each of the seventh and eighth embodiments, instead of the sealing agent 10 in the sixth embodiment, provides similar effects to those described above.

The sealing agents 10, 11 for use in any of the foregoing second embodiment to fifth embodiment are used as the sealing agents 10, 11 in this embodiment, providing similar effects to those described above.

In each of the foregoing first embodiment to ninth embodiment, each of the sealing agents 10, 12 corresponds to a first sealing agent, and the sealing agent 11 corresponds to a second sealing agent.

In each of the foregoing second embodiment to ninth embodiment, spacers may be used in order to deform the outer peripheral surface of the sealing agent 11 to a concave shape as in the first embodiment.

### INVENTIVE EXAMPLES

In each of Inventive Example 1 to Inventive Example 9, a single organic EL device was formed on a substrate, and the organic EL device was sealed according to the method in each of the first to ninth embodiments described above.

### Inventive Example 1

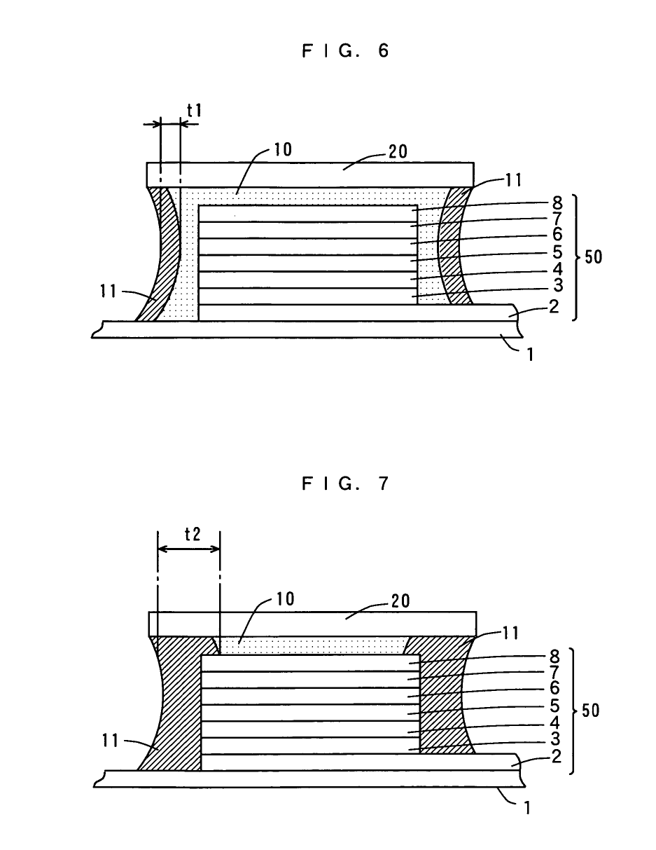

FIG. 6 is a schematic cross section showing the sealing structure of an organic EL device in Inventive Example 1. In Inventive Example 1, sealing was performed by the method in the above-described first embodiment.

As shown in FIG. 6, a single organic EL device 50 is formed on a substrate 1. A sealing agent 10 is formed on the upper surface and outer periphery of the organic EL device 50 on the substrate 1, and a sealing agent 11 is formed on the outer periphery of the sealing agent 10 on the substrate 1. A sealing plate 20 is bonded to the upper surface side of the sealing agent 10.

The organic EL device 50 was formed first on the substrate 1. A glass substrate was used as the substrate 1.

The organic EL device 50 has a laminated structure that includes a hole injection electrode 2, a hole injection layer 3, a hole transport layer 4, a light emitting layer 5, an electron transport layer 6, an electron injection layer 7, and an electron injection electrode 8. Ag was used as the hole injection electrode 2, and MgAg (magnesium silver) was used as the electron injection electrode 8.

Next, a film of the sealing agent 11 containing a filler was uniformly formed on the outer periphery of the lower surface of the sealing plate 20 by screen printing. The sealing agent 10 was then dropped onto a central portion of the sealing plate 20.

Glass was used for the sealing plate 20. As shown in Table 1, a UV curing epoxy resin was used for the sealing agent 10, and a UV curing epoxy resin containing a 30% SiO (filler) was used for the sealing agent 11. The viscosity of the sealing agent 10 was 5 Pa-s, and the viscosity of the sealing agent 11 was 50 Pa-s.

TABLE 1

| | sealing agent 10 | sealing agent 11 |
|---|---|---|
| material | UV curing epoxy resin | UV curing epoxy resin |
| filler | — | SiO (30%) |
| desiccant | — | — |
| viscosity | 5 Pa-s | 50 Pa-s |

After that, the sealing plate 20 and the substrate 1 were introduced into a vacuum chamber for the lamination of the sealing plate 20 and the substrate 1.

Each of the sealing plate 20 and the substrate 1 including the organic EL device 50 was mounted on a substrate holder in the vacuum chamber left open under atmospheric pressure. The vacuum chamber was hermetically sealed in this state, with the pressure in the vacuum chamber being reduced to a predetermined degree of vacuum.

Next, the sealing plate 20 and the substrate 1 were positioned opposite to each other in the vacuum chamber in a vacuum by the manipulation of the substrate holder, so that the sealing plate 20 and the substrate 1 were overlaid with each other. Then, the positions of the sealing plate 20 and the substrate 1 were again adjusted before the sealing plate 20 and the substrate 1 were laminated at a predetermined pressure.

After the lamination of the sealing plate 20 and the substrate 1, the vacuum chamber was released from its vacuum state, and the substrate 1 and sealing plate 20 laminated with each other were removed from the vacuum chamber. Finally, the sealing agents 10, 11 between the substrate 1 and the sealing plate 20 were cured by ultraviolet radiation. The sealing of the organic EL device 50 was thus completed.

The sealing agent 11 had a width t1 (dimension parallel to a surface of the substrate 1) of about 1 to 5 mm, and a thickness of about 0.5 to 2.0 mm between the lower surface of the substrate 1 and the upper surface of the sealing plate 20.

### Inventive Example 2

FIG. 7 is a schematic cross section showing the sealing structure of an organic EL device according to Inventive Example 2. In Inventive Example 2, the organic EL device 50 was sealed by the method in the above-described second embodiment. The sealing structure is similar to that of FIG. 6, and the sealing procedure is similar to that of Inventive Example 1, except the following.

During the formation of a sealing agent 11 film on the outer periphery of the lower surface of a sealing plate 20, the sealing agent 11 was formed to have a width t2 (dimension parallel to a surface of the substrate 1) greater than the width t1 of the sealing agent 11 in Inventive Example 1.

In Inventive Example 2, as shown in Table 2, a UV curing epoxy resin was used for a sealing agent 10, and a UV curing epoxy resin containing a 30% SiO (filler) was used for the sealing agent 11. The viscosity of the sealing agent 10 was 5 Pa-s, and the viscosity of the sealing agent 11 was 50 Pa-s.

TABLE 2

| | sealing agent 10 | sealing agent 11 |
|---|---|---|
| material | UV curing epoxy resin | UV curing epoxy resin |
| filler | — | SiO (30%) |
| desiccant | — | — |
| viscosity | 5 Pa-s | 50 Pa-s |

As a result of sealing the organic EL device 50 on a substrate 1 as described above, the width t2 of the sealing agent 11 was about 2 to 10 mm.

### Inventive Example 3

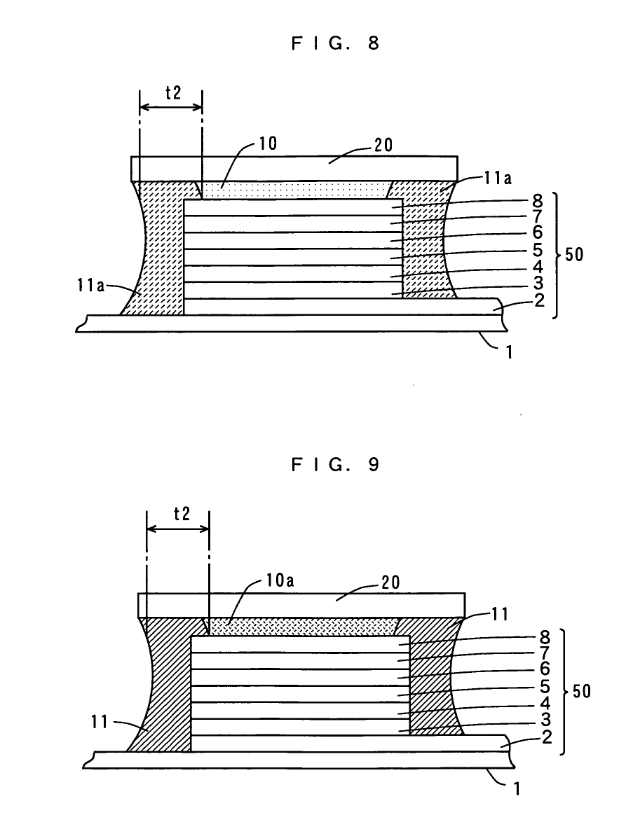

FIG. 8 is a schematic cross section showing the sealing structure of an organic EL device according to Inventive Example 3. In Inventive Example 3, the organic EL device 50 was sealed by the method in the above-described third embodiment. The sealing structure was similar to that of FIG. 7, and the sealing procedure was similar to that of Inventive Example 1, except the following.

Instead of the sealing agent 11 in FIG. 7, a sealing agent 11a containing a filler and a desiccant was used.

In Inventive Example 3, as shown in Table 3, a UV curing epoxy resin was used for a sealing agent 10, and a UV curing epoxy resin containing a 30% SiO (filler) and a 3% calcium oxide was used for the sealing agent 11a. The viscosity of the sealing agent 10 was 5 Pa-s, and the viscosity of the sealing agent 11 was 50 Pa-s.

TABLE 3

| | sealing agent 10 | sealing agent 11a |
|---|---|---|
| material | UV curing epoxy resin | UV curing epoxy resin |
| filler | — | SiO (30%) |
| desiccant | — | calcium oxide (3%) |
| viscosity | 5 Pa-s | 50 Pa-s |

As a result of sealing the organic EL device 50 on a substrate 1 as described above, the width t2 of the sealing agent 11a was about 2 to 10 mm.

### Inventive Example 4

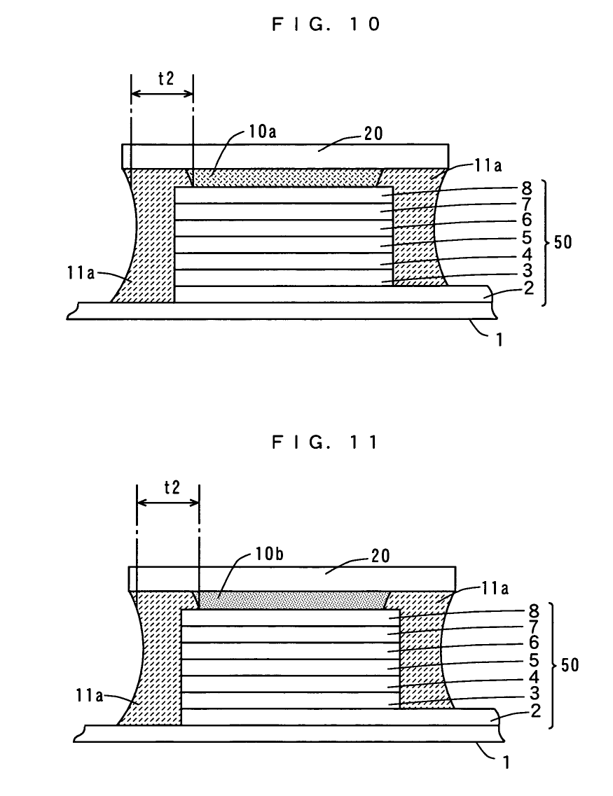

FIG. 9 is a schematic cross section showing the sealing structure of an organic EL device according to Inventive Example 4. In Inventive Example 4, the organic EL device 50 was sealed by the method in the above-described fourth embodiment. The sealing structure was similar to that of FIG. 7, and the sealing procedure was similar to that of Inventive Example 1, except the following.

Instead of the sealing agent 10 in FIG. 7, a sealing agent 10a containing a filler was used.

In Inventive Example 4, as shown in Table 4, a UV curing epoxy resin containing a 5% SiO (filler) was used for the sealing agent 10a, and a UV curing epoxy resin containing a 30% SiO (filler) was used for a sealing agent 11. The viscosity of the sealing agent 10a was 8 Pa-s, and the viscosity of the sealing agent 11 was 50 Pa-s.

TABLE 4

| | sealing agent 10a | sealing agent 11 |
|---|---|---|
| material | UV curing epoxy resin | UV curing epoxy resin |
| filler | SiO (5%) | SiO (30%) |
| desiccant | — | — |
| viscosity | 8 Pa-s | 50 Pa-s |

As a result of sealing the organic EL device 50 on a substrate 1 as described above, the width t2 of the sealing agent 11 was about 2 to 10 mm.

### Inventive Example 5

FIG. 10 is a schematic cross section showing the sealing structure of an organic EL device according to Inventive Example 5. In Inventive Example 5, the organic EL device 50 was sealed by the method in the above-described fifth embodiment. The sealing structure was similar to that of FIG. 7, and the sealing procedure was similar to that of Inventive Example 1, except the following.

Instead of the sealing agent 10 in FIG. 7, a sealing agent 10a containing a filler was used. Moreover, instead of the sealing agent 11 in FIG. 7, a sealing agent 11a containing a filler and a desiccant was used.

In Inventive Example 5, as shown in Table 5, a UV curing epoxy resin containing a 5% SiO (filler) was used for the sealing agent 10a, and a UV curing epoxy resin containing a 30% SiO (filler) and a 3% calcium oxide was used for the sealing agent 11a. The viscosity of the sealing agent 10a was 8 Pa-s, and the viscosity of the sealing agent 11a was 50 Pa-s.

TABLE 5

| | sealing agent 10a | sealing agent 11a |
|---|---|---|
| material | UV curing epoxy resin | UV curing epoxy resin |
| filler | SiO (5%) | SiO (30%) |
| desiccant | — | calcium oxide(3%) |
| viscosity | 8 Pa-s | 50 Pa-s |

As a result of sealing the organic EL device 50 on a substrate 1 as described above, the width t2 of the sealing agent 11a was about 2 to 10 mm.

### Inventive Example 6

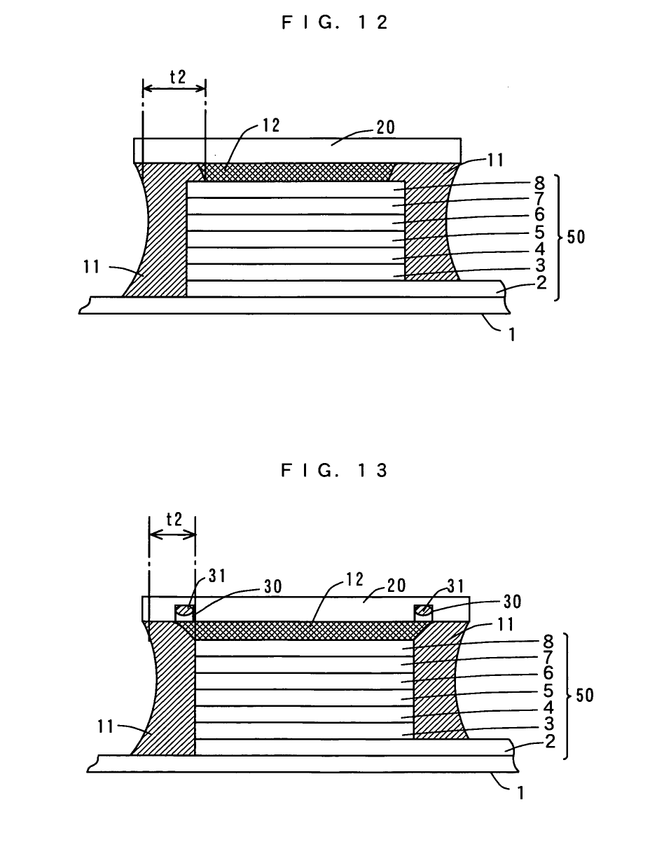

FIG. 11 is a cross section showing the sealing structure of an organic EL device according to Inventive Example 6. In Inventive Example 6, the organic EL device 50 was sealed by the method in the above-described sixth embodiment. The sealing structure was similar to that of FIG. 7, and the sealing procedure was similar to that of Inventive Example 1, except the following.

Instead of the sealing agent 10 in FIG. 7, a sealing agent 10b containing a filler and a desiccant was used. Moreover, instead of the sealing agent 11 in FIG. 7, a sealing agent 11a containing a filler and a desiccant was used.

In Inventive Example 6, as shown in Table 6, a UV curing epoxy resin containing a 5% SiO (filler) and a 3% calcium oxide was used for the sealing agent 10b, and a UV curing epoxy resin containing a 30% SiO (filler) and a 3% calcium oxide was used for the sealing agent 11a. The viscosity of the sealing agent 10b was 8 Pa-s, and the viscosity of the sealing agent 11a was 50 Pa-s.

TABLE 6

| | sealing agent 10b | sealing agent 11a |
|---|---|---|
| material | UV curing epoxy resin | UV curing epoxy resin |
| filler | SiO (5%) | SiO (30%) |
| desiccant | calcium oxide (3%) | calcium oxide (3%) |
| viscosity | 8 Pa-s | 50 Pa-s |

As a result of sealing the organic EL device 50 on a substrate 1 as described above, the width t2 of the sealing agent 11a was about 2 to 10 mm.

### Inventive Example 7

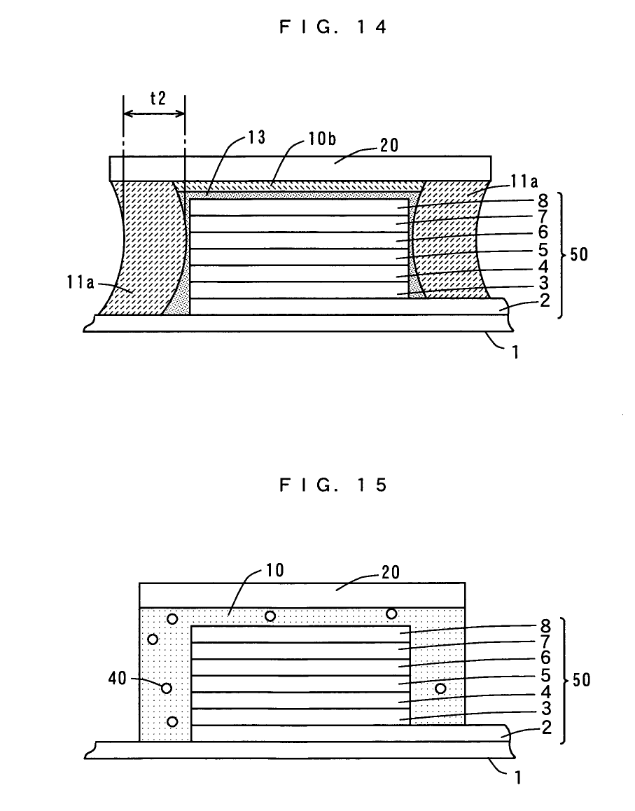

FIG. 12 is a schematic cross section showing the sealing structure of an organic EL device according to Inventive Example 7. In Inventive Example 7, the organic EL device 50 was sealed by the method in the above-described seventh embodiment. The sealing structure was similar to that of FIG. 7, and the sealing procedure was similar to that of Inventive Example 1, except the following.

A sealing agent 12 was used instead of the sealing agent 10 in FIG. 7. Moreover, the sealing procedure of the organic EL device 50 included applying the sealing agent 12 on a central portion of the lower surface of a sealing plate 20 (position on a plurality of organic EL devices 50 upon lamination) before the formation of a sealing agent 11 film on the sealing plate 20. Thus, dropping of the sealing agent 10 onto the sealing plate 20 as in Inventive Example 2 was excluded.

In Inventive Example 7, as shown in Table 7, a UV curing epoxy resin containing a 30% SiO (filler) was used for the sealing agent 11, and a butyl-based rubber adhesive sheet (adhesive film) was used for the sealing agent 12. The viscosity of the sealing agent 11 was 50 Pa-s.

TABLE 7

| | sealing agent 11 | sealing agent 12 |
|---|---|---|
| material | UV curing epoxy resin | butyl-based rubber |
| filler | SiO (30%) | |
| desiccant | — | |
| viscosity | 50 Pa-s | |

As a result of sealing the organic EL device 50 on a substrate 1 as described above, the width t2 of the sealing agent 11 was about 2 to 10 mm.

### Inventive Example 8

FIG. 13 is a schematic cross section showing the sealing structure of an organic EL device according to Inventive Example 8. In Inventive Example 8, the organic EL device 50 was sealed by the method in the above-described eighth embodiment. The sealing structure was similar to that of FIG. 12, and the sealing procedure was similar to that of Inventive Example 7, except the following.

Instead of the sealing plate 20 in FIG. 12, a sealing plate 20a provided with a groove 30 near an outer periphery was used. A desiccant 31 was stored in the groove 30.

The sealing procedure of the organic EL device 50 included forming beforehand the groove 30 near the outer periphery of the lower surface of the sealing plate 20, and making the sealing plate 20a by storing the desiccant 31 inside the groove 30. A sealing agent 12 was applied onto a central portion of the lower surface of the sealing plate 20a so as to cover the groove 30.

In Inventive Example 8, as shown in Table 8, a UV curing epoxy resin containing a 30% SiO (filler) was used for a sealing agent 11, and a butyl-based adhesive sheet was used for the sealing agent 12. The viscosity of the sealing agent 11 was 50 Pa-s.

TABLE 8

| | sealing agent 11 | sealing agent 12 |
|---|---|---|
| material | UV curing epoxy resin | butyl-based rubber |
| filler | SiO (30%) | |
| desiccant | — | |
| viscosity | 50 Pa-s | |

As a result of sealing the organic EL device 50 on a substrate 1, the width t2 of the sealing agent 11 was about 1 to 5 mm.

### Inventive Example 9

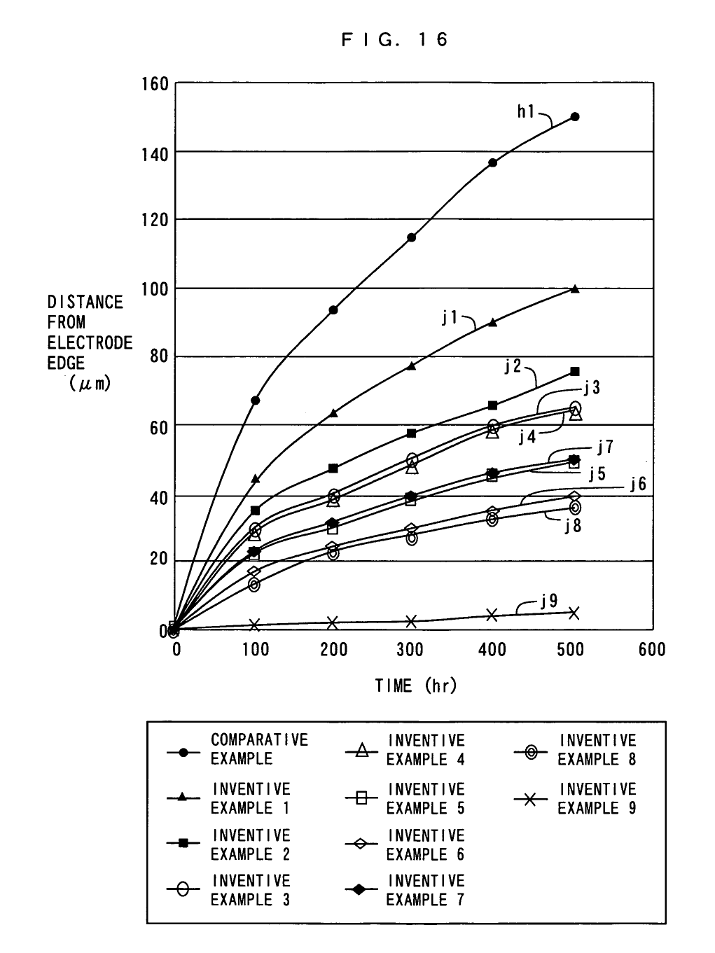

FIG. 14 is a schematic cross section showing the sealing structure of an organic EL device according to Inventive Example 9. In Inventive Example 9, the organic EL device 50 was sealed by the method in the above-described ninth embodiment. The sealing structure was similar to that of FIG. 7, and the sealing procedure was similar to that of Inventive Example 1, except the following.

A passivation layer 13 was formed on the upper surface and side surfaces of the organic EL device 50. Instead of the sealing agent 10 in FIG. 7, a sealing agent 10b containing a filler and a desiccant was used. Moreover, instead of the sealing agent 11 in FIG. 7, a sealing agent 11a containing a filler and a desiccant was used.

The sealing procedure of the organic EL device 50 included forming the passivation layer 13 on the upper surface and side surfaces of the organic EL device 50 by sputtering after the formation of the organic EL device 50 on a substrate 1. During the formation of a sealing agent 11 film on the outer periphery of the lower surface of the sealing plate 20, the sealing agent 11a was formed to have a width t2 greater than the width t1 of the sealing agent 11 in Inventive Example 1. After that, the substrate 1 and the sealing plate 20 were laminated through the sealing agents 10b, 11a to seal the organic EL device 50.

In Inventive Example 9, as shown in Table 9, a single-layer film of SiN was used for the passivation layer 13, a UV curing epoxy resin containing a 5% SiO (filler) and a 3% calcium oxide was used for the sealing agent 10b, and a UV curing epoxy resin containing a 30% SiO (filler) and a 3% calcium oxide was used for the sealing agent 11a. The viscosity of the sealing agent 10b was 8 Pa-s, and the viscosity of the sealing agent 11a was 50 Pa-s.

TABLE 9

| | sealing | sealing | protective |
|---|---|---|---|
| | agent 10b | agent 11a | film 13 |
| material | UV curing | UV curing | SiN single-layer |
| | epoxy resin | epoxy resin | film |
| filler | SiO (5%) | SiO (30%) | |
| desiccant | calcium oxide | calcium oxide | |
| | (3%) | (3%) | |
| viscosity | 8 Pa-s | 50 Pa-s | |

As a result of sealing the organic EL device 50 on a substrate 1, the width t2 of the sealing agent 11a was about 1 to 10 mm.

### Comparative Example

In Comparative Example, a single organic EL device was formed on a substrate, and the organic EL device was sealed according to the method shown below.

FIG. 15 is a schematic cross section showing the sealing structure of the organic EL device in Comparative Example.

As shown in FIG. 15, the single organic EL device 50 is formed on a substrate 1. A sealing agent 10 is formed on the top and outer periphery of the organic EL device 50 on the substrate 1, and a sealing plate 20 was bonded to the upper surface side of the sealing plate 10.

The organic EL device 50 was formed first on the substrate 1. A glass substrate was used as the substrate 1 as in Inventive Examples 1 to 9.

The organic EL device 50 has a similar structure to that of each of the organic EL devices in Inventive Examples 1 to 9, and uses similar electrodes to those in Inventive Examples 1 to 9 for a hole injection electrode 2 and an electron injection electrode 8.

Next, the sealing agent 10 was dropped onto the sealing plate 20. A glass was used as the sealing plate 20. As shown in Table 10, a UV curing epoxy resin was used for the sealing agent 10. The viscosity of the sealing agent 10 was 5 Pa-s.

TABLE 10

| | sealing agent 10 |
|---|---|
| material | UV curing epoxy resin |
| filler | — |
| desiccant | — |
| viscosity | 5 Pa-s |

After that, the sealing plate 20 and the substrate 1 were overlaid with each other through the sealing plate 10 in the atmosphere. In this state, the sealing plate 20 and the substrate 1 were laminated by applying a pressing force across the sealing plate 20 with a roller. Finally, the sealing agent 1 between the substrate 1 and the sealing plate 20 was cured by ultraviolet radiation. The sealing of the organic EL device 50 was thus completed.

In Comparative Example, foam 40 was confirmed inside the cured sealing agent 10 which was caused by the lamination of the substrate 1 and the sealing agent 10 in the atmosphere.

[Evaluation]

The organic EL devices 50 sealed in Inventive Examples 1 to 9 and Comparative Example described above were subjected to high temperature and high humidity tests in the following manner.

In the high temperature and high humidity tests, each of the sealed organic EL devices 50 was made to continuously emit light at a temperature of 85° C. and a humidity of 85% for measuring over time the spread of a non-luminescent area from an edge of the hole injection electrode 2. The non-luminescent area of each organic EL device 50 was visually determined by calculating the distance of the non-luminescent area from the edge of the hole injection electrode 2.

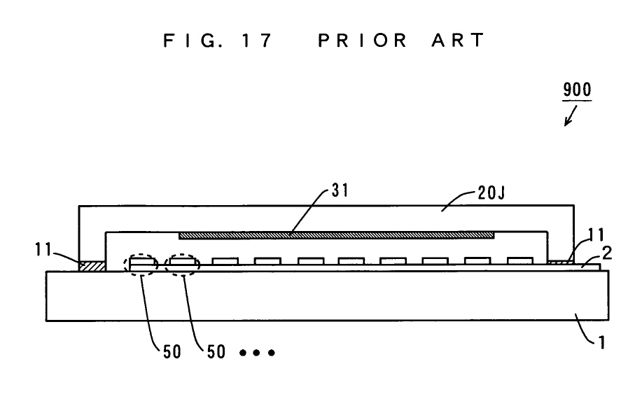

Results of the high temperature and high humidity tests on the organic EL devices 50 for Inventive Examples 1 to 9 and Comparative Example are given in Table 11 and FIG. 16. FIG. 16 is a graph showing the results of the high temperature and high humidity tests on the organic EL devices which were sealed in Comparative Example and Inventive Examples 1 to 9.

TABLE 11

| | | (hr) | | | | | |
|---|---|---|---|---|---|---|---|
| | target | 0 | 100 | 200 | 300 | 400 | 500 |
| distance | comparative | 0 | 67 | 93.8 | 115.9 | 137 | 150 |
| from | example | | | | | | |
| electrode | inventive | 0 | 44.8 | 62.7 | 77.5 | 89.6 | 100 |
| edge | example 1 | | | | | | |
| (μm) | inventive | 0 | 33.6 | 47.4 | 58.1 | 67.2 | 75 |
| | example 2 | | | | | | |
| | inventive | 0 | 29.1 | 41 | 50.3 | 58.2 | 65 |
| | example 3 | | | | | | |
| | inventive | 0 | 28.1 | 40 | 49 | 57 | 64 |
| | example 4 | | | | | | |
| | inventive | 0 | 22.4 | 31.6 | 38.7 | 44.8 | 50 |
| | example 5 | | | | | | |
| | inventive | 0 | 17.9 | 25.3 | 30.9 | 35.8 | 40 |
| | example 6 | | | | | | |
| | inventive | 0 | 23 | 33 | 40 | 46 | 51 |
| | example 7 | | | | | | |
| | inventive | 0 | 15 | 24 | 29 | 34 | 38 |
| | example 8 | | | | | | |
| | inventive | 0 | 2.24 | 3.16 | 3.88 | 4.47 | 5 |
| | example 9 | | | | | | |

As shown in Table 11, for the organic EL device 50 sealed in Comparative Example, a non-luminescent area of 67 μm was observed from an edge of the hole injection electrode 2 upon 100-hr continuous light emission; a non-luminescent area of 93.8 μm upon 200-hr continuous light emission; a non-luminescent area of 115.9 μm upon 300-hr continuous light emission; a non-luminescent area of 137 μm upon 400-hr continuous light emission; and a non-luminescent area of 150 μm upon 500-hr continuous light emission. Changes over time in this non-luminescent area are indicated by the curve h1 in FIG. 16.

On the other hand, for the organic EL device 50 sealed in Inventive Example 1, the generation and expansion of the non-luminescent area was reduced by about 33% as compared to the changes over time in the non-luminescent area of the organic EL device 50 sealed in Comparative Example. Changes over time in this non-luminescent area are indicated by the curve j1 in FIG. 16.

For the organic EL device 50 sealed in Inventive Example 2, the generation and expansion of the non-luminescent area was reduced by about 50% as compared to the changes over time in the non-luminescent area of the organic EL device 50 sealed in Comparative Example. Changes over time in this non-luminescent area are indicated by the curve j2 in FIG. 16.

For the organic EL device 50 sealed in Inventive Example 3, the generation and expansion of the non-luminescent area was reduced by about 56% as compared to the changes over time in the non-luminescent area of the organic EL device 50 sealed in Comparative Example. Changes over time in this non-luminescent area are indicated by the curve j3 in FIG. 16.

For the organic EL device 50 sealed in Inventive Example 4, the generation and expansion of the non-luminescent area was reduced by about 57% as compared to the changes over time in the non-luminescent area of the organic EL device 50 sealed in Comparative Example. Changes over time in this non-luminescent area are indicated by the curve j4 in FIG. 16.

For the organic EL device 50 sealed in Inventive Example 5, the generation and expansion of the non-luminescent area was reduced by about 66% as compared to the changes over time in the non-luminescent area of the organic EL device 50 sealed in Comparative Example. Changes over time in this non-luminescent area are indicated by the curve j5 in FIG. 16.

For the organic EL device 50 sealed in Inventive Example 6, the generation and expansion of the non-luminescent area was reduced by about 73% as compared to the changes over time in the non-luminescent area of the organic EL device 50 sealed in Comparative Example. Changes over time in this non-luminescent area are indicated by the curve j6 in FIG. 16.

For the organic EL device 50 sealed in Inventive Example 7, the generation and expansion of the non-luminescent area was reduced by about 66% as compared to the changes over time in the non-luminescent area of the organic EL device 50 sealed in Comparative Example. Changes over time in this non-luminescent area are indicated by the curve j7 in FIG. 16.

For the organic EL device 50 sealed in Inventive Example 8, the generation and expansion of the non-luminescent area was reduced by about 75% as compared to the changes over time in the non-luminescent area of the organic EL device 50 sealed in Comparative Example. Changes over time in this non-luminescent area are indicated by the curve j8 in FIG. 16.

For the organic EL device 50 sealed in Inventive Example 9, the generation and expansion of the non-luminescent area was reduced by about 96% as compared to the changes over time in the non-luminescent area of the organic EL device 50 sealed in Comparative Example. Changes over time in this non-luminescent area are indicated by the curve j9 in FIG. 16.

The foregoing results show that for all of the organic EL devices 50 sealed in Inventive Examples 1 to 9, progress of deterioration upon continuous light emission is reduced, as compared to the organic EL device 50 which was sealed in the atmosphere, using only the sealing agent 10 in Comparative Example.

In addition, the overall thickness of each of the organic EL devices 50 sealed in Inventive Examples described above is from about 0.5 to 2.0 mm. On the other hand, the use of the sealing can 20J instead of the sealing agent 10 as shown in FIG. 17 requires an overall thickness of about 2.2 mm or greater. Therefore, a thinner sealing structure is achieved for each of the organic EL devices 50 fabricated in Inventive Examples described above.

1. A method of fabricating an organic electroluminescent apparatus comprising the steps of:
forming one or a plurality of organic electroluminescent devices on a substrate;
providing one or more kinds of sealing agents for sealing said one or plurality of organic electroluminescent devices on at least one of said substrate and a sealing plate;
laminating said substrate and said sealing plate through said sealing agent under a reduced pressure; and
placing said substrate and said sealing plate laminated through said sealing agent in the atmosphere to cure said sealing agent.

2. The method of fabricating an organic electroluminescent apparatus according to claim 1, wherein
said one or more kinds of sealing agents include a first sealing agent of one kind and a second sealing agent of another kind, said first sealing agent having a lower viscosity than that of said second sealing agent, said first sealing agent being provided so as to seal said one or plurality of organic electroluminescent devices on said substrate, said second sealing agent being provided on an outer peripheral portion on said substrate so as to surround said one or plurality of organic electroluminescent devices.

3. An organic electroluminescent apparatus comprising;
a substrate;
one or a plurality of organic electroluminescent devices arranged on said substrate; and
a plurality of kinds of sealing agents for sealing said one or plurality of organic electroluminescent devices, wherein
a first sealing agent of one kind of said plurality of kinds of sealing agents seals said one or plurality of organic electroluminescent devices, and a second sealing agent of another kind of said plurality of kinds of sealing agents seals an outer peripheral portion on said substrate so as to surround said one or plurality of organic electroluminescent devices.

4. The organic electroluminescent apparatus according to claim 3, wherein
said first sealing agent has a lower viscosity than that of said second sealing agent.

5. The organic electroluminescent apparatus according to claim 4, wherein
a filler is added to said first sealing agent.

6. The organic electroluminescent apparatus according to claim 4, wherein
a desiccant is added to said first sealing agent.

7. The organic electroluminescent apparatus according to claim 4, wherein
said first sealing agent is made of an adhesive.

8. The organic electroluminescent apparatus according to claim 3, wherein
said first sealing agent is made of an adhesive in sheet form.

9. The organic electroluminescent apparatus according to claim 3, wherein
a filler is added to said second sealing agent.

10. The organic electroluminescent apparatus according to claim 3, wherein
a desiccant is added to said second sealing agent.

11. The organic electroluminescent apparatus according to claim 3, wherein
said second sealing agent is in contact with said one or plurality of organic electroluminescent devices.

12. The organic electroluminescent apparatus according to claim 3, wherein
said substrate is laminated with a sealing plate through said plurality of kinds of sealing agents.

13. The organic electroluminescent apparatus according to claim 12, wherein
a storage portion for storing a desiccant is provided on a surface of said sealing plate opposite to said substrate.

14. The organic electroluminescent apparatus according to claim 12, wherein
said sealing plate is made of an optically transparent material, and a color filter is provided on said surface of said sealing plate opposite to said substrate.

15. The organic electroluminescent apparatus according to claim 3, wherein
said one or plurality of organic electroluminescent devices are covered with a passivation layer comprising a single layer or a plurality of layers.

16. An organic electroluminescent apparatus comprising:
a substrate;
one or a plurality of organic electroluminescent devices arranged on said substrate;
a sealing agent for sealing said one or plurality of organic electroluminescent devices on said substrate; and
a sealing plate laminated to said substrate through said sealing agent, wherein
an outer peripheral surface of said sealing agent between said substrate and said sealing plate is formed in a concave shape.
